(19) United States
(12) Patent Application Publication
(10) Pub. No.: US 2025/0305800 A1
(43) Pub. Date: Oct. 2, 2025

(54) DISPLAY BOARD BALLISTIC SHIELD

(71) Applicant: Israel S. Fried, Cedarhurst, NY (US)

(72) Inventor: Israel S. Fried, Cedarhurst, NY (US)

(21) Appl. No.: 19/116,317

(22) PCT Filed: Oct. 2, 2023
(86) PCT No.: PCT/US23/34267

§ 371 Date: Mar. 27, 2025

Related U.S. Application Data
(60) Provisional application No. 63/412,015, filed on Sep. 30, 2022.

(51) Int. Cl. F41H 5/14; B43L 1/00; B43L 1/06; G09F 15/00

(52) U.S. Cl. CPC F41H 5/14; B43L 1/00; B43L 1/06; G09F 15/00

(57) ABSTRACT

A display board ballistic shield to protect students from gunfire includes a U-shaped base frame comprising a vertically oriented rectangular frame having two vertical posts, a top, and a bottom. The frame defines a vertical plane and a window area therethrough. A base leg having two ends is affixed to each side of the frame at a bottom thereof, each base leg perpendicularly oriented to the plane defined by the frame. A caster is affixed proximate to the ends of each of the base legs. A first ballistic resistant panel has a rectangular metal frame and is mounted within a bottom portion of the frame and coplanar therewith. A second ballistic resistant panel has a rectangular metal frame and is mounted within a top portion of the frame. The second ballistic resistant panel also includes a dry erase display board abutting in layered fashion the second ballistic resistant panel.

### CROSS-REFERENCE TO RELATED APPLICATION

This application claims the benefit of co-pending U.S. Provisional Patent Application Ser. No. 63/412,015, filed on 30 Sep. 2023, which is incorporated herein in its entirety.

### FIELD OF THE INVENTION

This disclosure relates to apparatuses and methods for a ballistic shield. More particularly, the present disclosure relates to a mobile ballistic shield which also functions as a display board (e.g. a dry erase board, blackboard or bulletin board).

### BACKGROUND OF THE INVENTION

Our society was introduced to a particularly increasing incident of deadly tragedies starting with the Columbine High School shootings of Apr. 20, 1999. The tragic loss of lives and the injuries has too often been repeated in schools across our country. Many times, the shooter will enter a classroom that only has one point of ingress and egress. The children and teacher thereby become captive targets for the shooter and are not able to escape. The result is loss of children's lives, loss of school staff' s lives, and severe injuries to those lucky enough to escape death. This does not even count the emotional damage that the experience imparts to the survivors and their families.

Schools are often labeled as “gun free” in an attempt to keep firearms out of the school. However, words and labels all too often fail to deter a person intent on causing harm with a firearm. Other measures that have been implemented to keep potential shooters out of the school include keeping the building doors locked during the school day, installing locks on classroom doors, allowing access only with issued identification badges, and hiring professional hall monitors who may or may not be armed. Regardless of the implementation of one or more of these or other measures, shooters have still been able to access the school building to render their terror, and even if the classroom doors are locked, a high powered rifle will still penetrate the door.

As a result, there is a pressing need in the art for products to protect innocent members of educational institutions, and other institutions, from serious injury.

### SUMMARY OF THE INVENTION

In accordance with the invention, a display board or white board ballistic shield is disclosed which shields individuals, such as children and teachers, by using a mobile platform providing 24 square feet of ballistic protection.

In a preferred embodiment, the white board ballistic shield according to the present invention is placed in a classroom or other setting to allow students or others to safely egress the room and move behind cover to safety. Preferably, the level of protection provided by the white board ballistic shield is the same as the shields provided to law enforcement responding to these incidents.

In a further preferred embodiment, the invention serves as an entryway shield. If the threat from an active shooter is in the immediate area of the classroom, preventing the classroom students and teacher to egress, the white board ballistic shield can be moved in front of the door to the classroom. The while board can be affixed to the door, locking itself to the frame and to the door itself. Thereby, the whiteboard seals the room, and provides a ballistic barricade between the threat and the individuals inside the room.

In accordance with the invention, a white board ballistic shield for use in school classrooms to protect students from gunfire includes a polygonal metal frame constructed of a plurality of lengths of angle elements, the angle legs in one plane forming a frame defining a window area and the angle legs extending at right angles from the plane of the frame defining a polygonal recess. A white board panel is retained within the polygonal recess, the white board surface accessible through the window. A ballistic resistant panel is positioned within the polygonal recess and abuts the white board in a layered fashion, and a backing board is also layered within the polygonal recess and abuts the ballistic resistant panel. A plurality of gussets are affixed at corners of adjoining lengths of angle elements to retains the white board panel, the ballistic resistant panel, and the backing board within the polygonal recess.

In another aspect of the invention, the metal frame is constructed of steel angles.

In a further aspect of the invention the white board panel is magnetic.

In an additional aspect, the backing board is configured as a dry erase board panel, or a blackboard or bulletin board panel, the board surface facing opposite from the window.

In yet another aspect of the invention the polygonal metal frame includes hinge brackets affixed to a first side of the metal frame for mating with mounting brackets affixed to a door frame.

In yet a further aspect of the invention the polygonal metal frame rotates about the hinge brackets and rotates to cover a door mounted to the door frame.

In an additional aspect a base frame movably supporting the white board ballistic shield is also included. The base frame includes two vertical upright posts laterally separated one from the other and a lateral tube connected to the bottoms of the upright posts. The vertical upright posts and lateral tube define a vertical plane. A base leg is affixed to the bottom of each vertical upright post and oriented perpendicularly to the vertical plane and a caster is affixed proximate to the ends of each of the base legs.

In a further aspect a white board ballistic shield for use in school classrooms to protect students from gunfire, the shield includes a vertically oriented rectangular frame having two sides, a top, and a bottom, The frame defines a vertical plane and further defines a window area therethrough. A ballistic resistant panel is mounted within the frame and is coplanar therewith. A base leg having two ends is affixed to each side of the frame at the bottom thereof, each base leg perpendicularly oriented to the plane defined by the frame. A caster is affixed proximate to the ends of each of the base legs.

In yet another aspect at least one handle is affixed to the frame.

In an additional aspect the rectangular frame defines a central window area and further includes a white board panel mounted within the frame in layered fashion with the ballistic resistant panel. The white board panel has a surface for marking or posting thereon, and the white board surface is visible through the window area defined by the frame.

In still a further aspect, a backing panel is mounted within the frame in layered fashion with the ballistic resistant panel and on an opposite side of the ballistic resistant panel from the white board panel.

In another aspect, the backing panel is a second white board panel wherein the white board surface of the second panel is oriented facing oppositely from the white board surface of the first white board panel.

In yet another aspect a white board ballistic shield for use in school classrooms to protect students from gunfire includes a U-shaped base frame comprising a vertically oriented rectangular frame having two vertical posts, a top, and a bottom. The frame defines a vertical plane and a window area therethrough. A base leg having two ends is affixed to each side of the frame at a bottom thereof, each base leg perpendicularly oriented to the plane defined by the frame. A caster is affixed proximate to the ends of each of the base legs. A first ballistic resistant panel has a rectangular metal frame and is mounted within a bottom portion of the frame and coplanar therewith. A second ballistic resistant panel has a rectangular metal frame and is mounted within a top portion of the frame. The second ballistic resistant panel also includes a white board abutting in layered fashion the second ballistic resistant panel.

In still another aspect, a bottom of the second ballistic resistant panel overlaps the top of the first ballistic resistant panel.

In a further aspect, the ends of the base legs on one side of the shield define a vertical hole therethrough, the base leg ends being received in a bracket affixed to each side of a doorframe. The brackets define a vertical hole therethrough such that when the base legs are received in the brackets, a pin can be inserted through the aligned holes to lock the ballistic shield to the doorframe.

In an additional aspect, a first vertical post includes at least one bracket affixed thereto and a second vertical post includes at least one mating bracket affixed thereto in horizontal alignment with the bracket affixed to the first vertical post such that multiple white board ballistic shields can be affixed one to the other in a daisy-chain manner to create an extended white board ballistic shield wall.

Further embodiments and features of the invention will become apparent in conjunction with the detailed description of the inventions and their preferred embodiments provided hereafter.

### BRIEF DESCRIPTION OF THE DRAWINGS

The invention will now be described, by way of example, with reference to the accompanying drawings, where like numerals denote like elements and in which:

FIG. 1 presents a basic white board ballistic shield panel which forms the basis for all embodiments;

FIG. 2 presents an isometric view of a free standing white board ballistic shield with casters for moving the board;

FIG. 3 presents an isometric view of a free standing white board ballistic shield comprising multiple ballistic panels;

FIG. 4 presents a side view of an alternate embodiment free standing white board ballistic shield wherein the top ballistic panel is hinged to rotate out of the vertical;

FIG. 5 presents an isometric view of the ballistic panel of FIG. 3 wherein the base panel supports are received in wall fixtures to mount the ballistic panel to block a doorway;

FIG. 6 presents a plurality of ballistic panels which are attached side-by-side to block a hallway;

FIG. 7 presents a ballistic panel mounted on a doorframe with hinges to allow the ballistic panel to be rotated in front of a door to block the door.

Like reference numerals refer to like parts throughout the various views of the drawings.

### DETAILED DESCRIPTION OF THE INVENTION

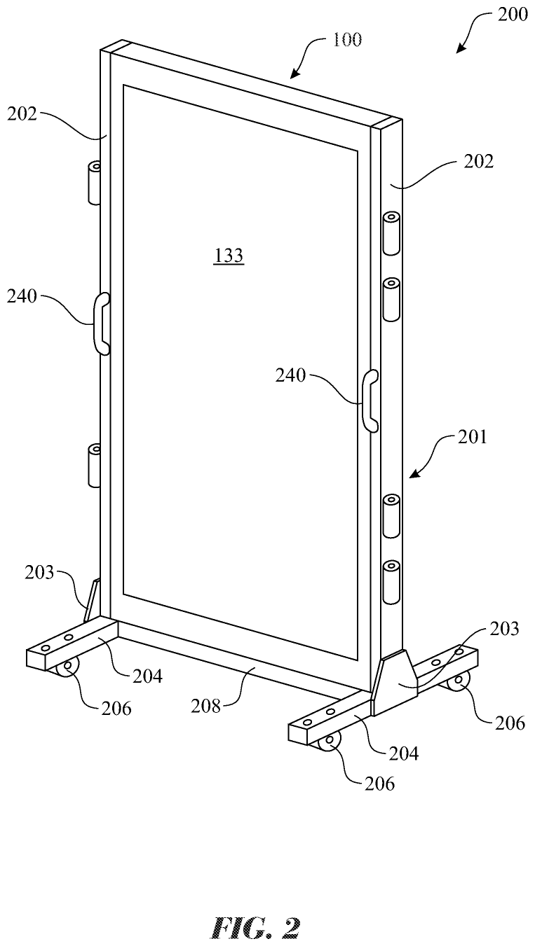

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 2. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with the design and methods of the invention, a defensive white board ballistic shield 200, FIG. 2. By way of definition, applicant includes in the term “white board” or “display board” not only dry erase boards, but also blackboards, and bulletin boards. The white board can hide in plain sight as a fully functional mobile magnetic dry erase board, blackboard, or bulletin board. The design allows the white board ballistic shield 200 to look as if it belongs in, and is a normal part of, the classroom, blending into the aesthetic, and not causing fear or anxiety for young students.

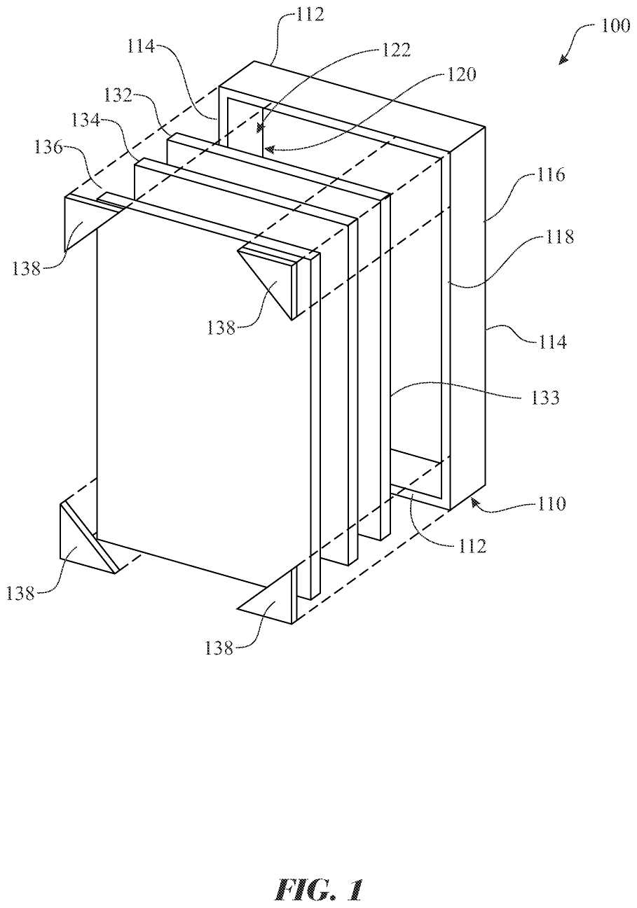

Referring first to FIG. 1, each of the embodiments described herein utilizes as its core a white board ballistic panel 100, the size and dimensions of which can be modified to adapt to the purpose for which it is intended to be used. The panel 100 comprises a polygonal frame 110 of metallic angle segments 112, 114 having their respective ends fastened one to another to form the desired polygonal form, here shown as a rectangle. The joined segments 112, 114 define a recess 122 at the back 118 of the frame 110 while a front 116 of the frame 110 defines a window 120. A plurality of panels 132, 134, 136 are received in a stacked configuration wherein panel 132 is a white board panel (a dry erase board, blackboard, or bulletin board), either magnetic or non-magnetic, having a surface 133 which is visible through the window 120 of frame 110 and is accessible for writing thereon with dry erase markers (not shown) of known configuration or posting objects thereon (e.g., with thumbtacks). A middle panel 134 is a ballistic resistant panel having a minimum level 1 ballistic rating. A third panel 136 is at the rear of the frame 100 and can be a steel plate for additional ballistic protection, a second white board panel (magnetic or non-magnetic), or a blank panel. The panels 132, 134, 136 are retained in recess 122 with triangular gussets 138 affixed at the corners of frame 110.

FIG. 2 illustrates a first embodiment of a mobile defensive white board ballistic shield 200. A white board ballistic panel 100 is mounted in a base frame 201. As to the frame 201, in the preferred embodiment, the frame 201 is fabricated from parts made of steel (or another suitable material), welded together for added strength and durability. Preferably, there is essentially one solid support frame 201, without numerous individual parts. The base frame 201 is preferably a completely welded U shaped frame using square steel tube with legs that have wheels under them. It is made from five (5) pieces of square tube steel welded together to form one solid piece for added strength and durability and wheels welded on to make it mobile. There are no screws or added hardware, which could impact or affect the integrity of the design. It also keeps the frame 201 lighter and easier to move and impervious to mechanical or design failures.

Preferably, two upright posts 202 are made from 74″ (height)×1″×1″ steel square tube. The two upright posts 202 are welded into the center of two base legs 204 that are 20″×1¼″×1¼″ square steel tube and a trapezoidal gusset 203 is welded at the joint of the upright posts 202 and the base leg 204. Additionally, the two base legs 204 have two 360 degree swivel caster wheels 206 welded to the underside of each base leg 204. One caster 206 in the front and one caster in the back. Each caster 206 is preferably rated to 200-500+ lbs (or greater depending on the rating of the ballistic panels). To provide stability, the two base legs are laterally connected by a third lateral steel square tube 208 that is 48¼″ (wide)×1″×1″.

Preferably, the defensive white board ballistic shield 200 is lightweight. For example, in one preferred embodiment, a white board ballistic shield with a ballistic level 1 rating is provided which weighs under 100 lbs. while providing 24 square feet of ballistic coverage. In the past, most school related active shooter events have involved a 9 mm handgun, which a level 1 ballistic panel is rated to protect against up to 4 bullet impacts. In accordance with the preferred embodiment, the defensive white board ballistic shield 200 and its integrity remains intact despite being hit with in excess of 60+ rounds of 9 mm ammunition.

In addition, the white board ballistic shield 200 is very versatile. Because it is lightweight, it is easily movable. The caster wheels 206 on which it is supported, are preferably each rated for 200-500 lbs. of weight making it virtually effortless to move the board.

Furthermore, handles 240 are preferably mounted to the mobile support frame 201 making maneuvering the white board ballistic shield 200 in confined and narrow spaces much easier.

In one use, the white board ballistic shield 200 provides teachers and students with a shield that serves as a safe and effective way of egressing the classroom in the event of an active shooter event, while providing the same level of protection as is given to law enforcement who would respond to such event. As such, it gives students and teachers the opportunity to get to safety in a safe and efficient manner and get away from the danger as quickly as possible. Due to the size and maneuverability of the board, a teacher can evacuate a classroom in a similar fashion as a fire drill, lining the students up in a single file line behind the white board ballistic shield 200, grasping the handles 240 and then using the white board ballistic shield 200 as a mobile shield to hide behind as they egress the classroom. The teacher can move the shield 200 along a hallway wall to an emergency exit by pushing it in front of the line of students who are secreted and hidden behind it.

In a further embodiment 300, the ballistic panel is divided into two parts, an upper panel 101 and a lower panel 102. The upper panel 101 of the white board ballistic shield contains a display board 132 (such as a magnetized dry erase board or blackboard or bulletin board) with a surface 133 and is the only moving part in the entire design other than the casters 306 which have simple hardware. This increases strength and versatility, and eliminates, as much as possible, parts breaking or impeding the intent of the board. The lower panel 102 has a generic surface 135, which can be a non-writable or writable surface.

In a preferred embodiment, the white board ballistic shield includes a combination of some or all of the following 7 components, and any further components useful or desired by one of skill in the art. These components comprise of the following:
1. The Frame (preferably at least 1)
2. Casters/wheels (preferably at least 4)
3. Ballistic Panels (preferably at least 2)
4. Display board (e.g. a magnetic dry erase board, blackboard, or bulletin board) (preferably at least 1)
5. Paneling (preferably at least 3)
6. Handles (preferably at least 3)
7. Bolts (preferably at least 2), washers (preferably at least 4), and nuts (preferably at least 2)

The white board ballistic shield 300 contains at least two ballistic fiberglass panels 101, 103 which overlap one another. Each ballistic panel 101, 103 is encased in a frame using right angle steel cut to size. The upper ballistic panel 101 preferably measures at least 48″ wide×36″ high. The upper ballistic panel 134 is provided with a display board 132 of equal proportions in front of it and a blank 136 panel behind it. The display board 132 and blank panel 136 also preferably measures 48″ wide×36″ high.

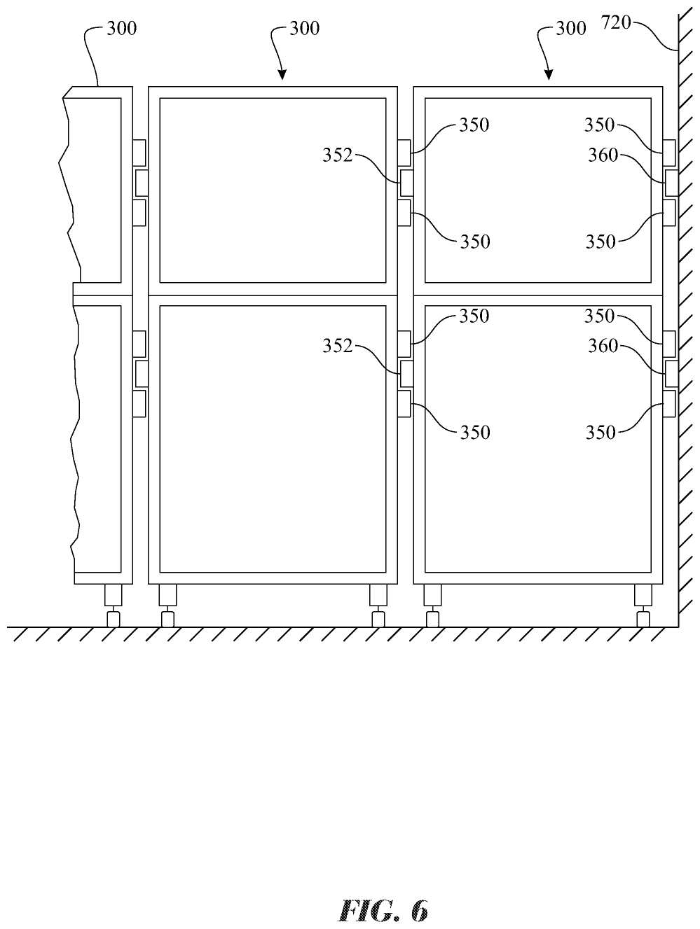

In a further embodiment as illustrated in FIGS. 2, 3 and 6, brackets 250, 252, 350, 352 are provided on one or preferably both upright posts 202, 302 (both right and left), to allow one board 200, 300 to be connected to a second, and third, and so on. Thus, several boards can be linked (“daisy chained”) together forming a ballistic wall across an entire hallway or other area, using the mounting brackets 250, 252, 350, 352 on either side of the upright posts to link the boards together. Further preferably, the two outermost boards are mounted directly to mounting brackets 360 staged at pre-designated intervals along each of the hallway walls 720 in the school, effectively creating a ballistic shield impervious to incoming fire and which effectively seals off an entire hallway with a wall-to-wall ballistic shield.

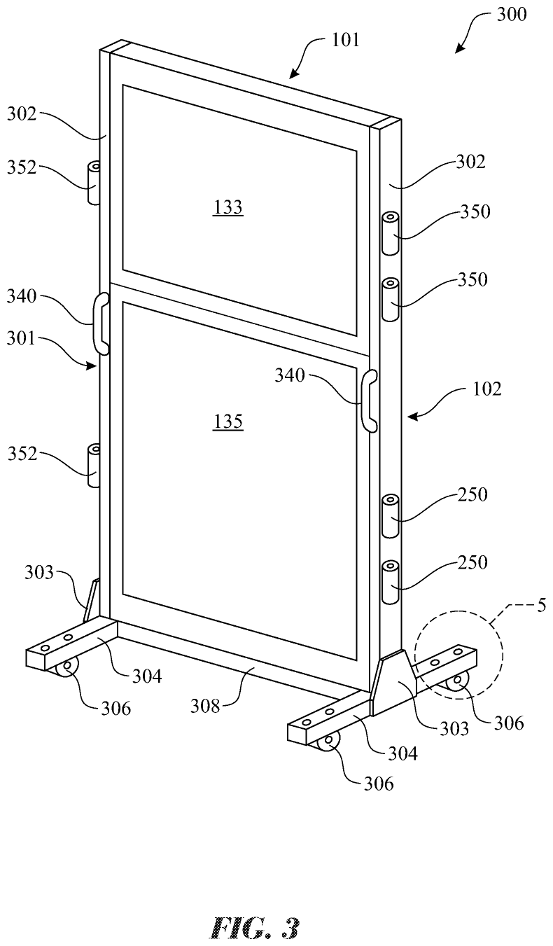

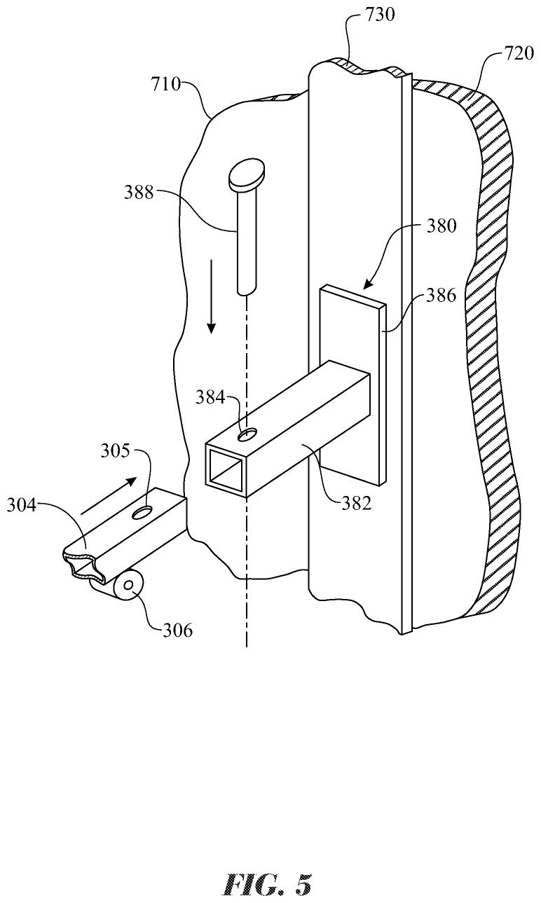

In an additional embodiment as illustrated in FIGS. 3 and 5, should an active shooter event create a danger precluding egress from the classroom, the white board ballistic shield 300 can be moved in front of the classroom door and locked into place over the frame of the door, by sliding the base legs 304 into mounting brackets 380 welded to either side of the door, and dropping in locking pins 388 which affix the white board ballistic shield 300 into place making it immobile. The mounting bracket 380 has a base plate 386 which is welded to the metal door frame 730. A receiving tube 382 is welded to the base plate 386 and extends from the plate 386 in a cantilevered fashion. The receiving tube 382 is sized to internally receive an end of the base leg 304 of the support frame 302. The receiving tube 382 defines a vertical hole 384 which aligns with a like vertical hole 305 in the base leg 304 for receiving the locking pin 386. In terms of the door to the classroom, two additional previously mounted receiving brackets are affixed to the door itself. Then brackets are used, which have one side which slides into the door mounted bracket, and the other side coupled to the upper frame of the lower ballistic panel, thereby keeping the door from either swinging inward or outward. The rigidity of the entire white board ballistic shield being mounted into the doorframe, coupled with the connecting of the classroom door to the frame of the board itself, makes opening the door inward or outward virtually impossible due to the design and connection to the board.

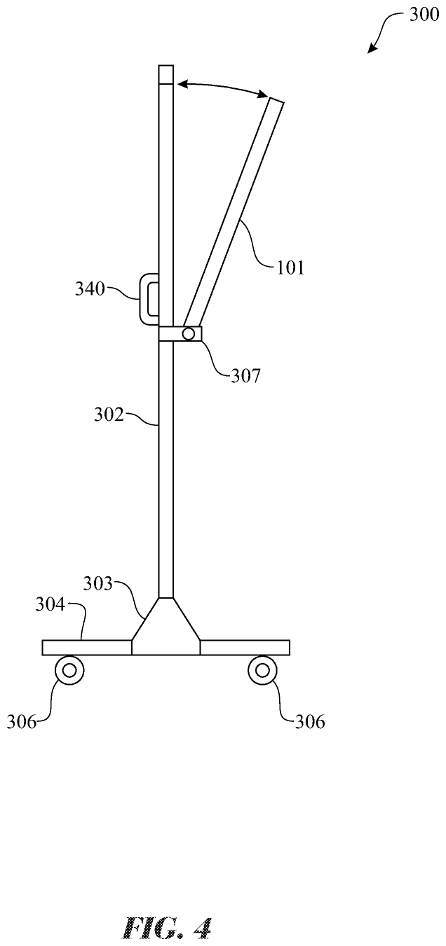

Turning now to FIGS. 3 and 4, the upper ballistic panel 101 is rotatable about a horizontal axis with respect to the base frame 301 about hinge 307, allowing it to swing either forward and down (as shown), or backward and up, allows the white board ballistic shield 300 to provide coverage from high angle ballistic threats be they in stairwells or in situations where there are two tiers of exposure to lower walkways. Being able to angle the upper ballistic board toward a threat from above or below, based on how the board is angled, provides the flexibility to move and have protection in situations where the threat presented comes from either above or below. A rigid board stuck in an upright position would be ineffective in those situations and scenarios.

The ballistic fiberglass panel 134, the display board 132 and blank panel 136 are preferably welded together in a frame 110 made from right angle steel around the perimeter of both board and panels sandwiched together with the display board on top and blank panel on bottom. Four steel gussets 138 are preferably used to secure the boards 132, 136 and panel 134 within the frame 110 by welding them to the right angles of each inside corner of the right angled steel frame 110 securing both boards 132, 136 and panel 134 in place and making them immobile.

The display board functions as a regular white dry erase board, blackboard, or bulletin board found in any classroom across the United States. If it is a dry erase board, it is fully functional to write on with generic dry erase markers and is magnetized to accept accessories that might be adhered to it such as a marker and eraser holder, clock, or usual classroom materials. Likewise, as a blackboard it can be used with erasable chalk, or as a bulletin board, objects can be affixed to it with thumbtacks, or so forth.

The lower ballistic panel 103 preferably measures at least 48″ wide×42″ high. The lower ballistic panel 134 is provided with a blank sheet of paneling 132 of equal proportions, e.g., 48″ wide×42″ high in front of it and behind it.

In accordance with the embodiments, the ballistic panels which are provided can be panels rated anywhere from a Level 1 up to Level 8. The higher the level rating, the greater the ballistic protection. Level 1 stops up to 4 rounds of a 9 mm handgun. Level 8 stops multiple rounds from a rifle chambered for 7.62 mm ammunition. The higher the level of the ballistic panel used, the thicker the panel, thus impacting the size of the right angle steel used to frame it together with the dry erase board and blank paneling.

Preferably, the lower ballistic panel 103 is welded directly to the base frame 301 at the four corners of the panel frame, to the four points of contact on the lower portion of the upright posts 302.

Two welds to the lower two corners of the lower ballistic panel 103 are on the upright post 302 where it meets the base legs 304. Two welds to the upper two corners of the lower ballistic panel 103 are on the upright post 302 where the upper two corners of the lower ballistic panel position once the lower two corners are welded to upright post at the point of contact with the base legs 304.

The upper ballistic panel 101 is preferably mounted inside the upright posts 302 and inside the upper portion of the lower ballistic panel 103 already welded to the upright posts. The upper ballistic panel 101, for example, can be mounted using a hexagon bolt/screw through the middle of the right and left upper ballistic panel 103 right and left frame and the upright post 302 of the base frame with washers on either side of the upright post and locking nut on the outside of the upright posts. The hexagon bolt/screw mounting system for the upper ballistic panel 101 allows the panel to be free floating, and to rotate forward and down and then backwards and upwards.

When vertical and straight, the lower portion of the upper ballistic panel 101 will sit, for example, 3 inches below and slightly behind the upper portion of the lower ballistic panel, which will overlap and sit slightly in front of the lower portion of the upper ballistic panel 101. This provides overlapping coverage in the middle of the white board ballistic shield 300 where the handles 304 are mounted for assisting in moving the board.

For example, two handles are welded to the top and front facing side of the frame 110 to the lower ballistic panel 103 equidistant from the top right and left corners of the lower ballistic panel 103. A single handle is also mounted to the top and front facing side of the frame 110 to the upper ballistic panel 101, equidistant from the top right and left corners or squarely in the middle of the front facing frame.

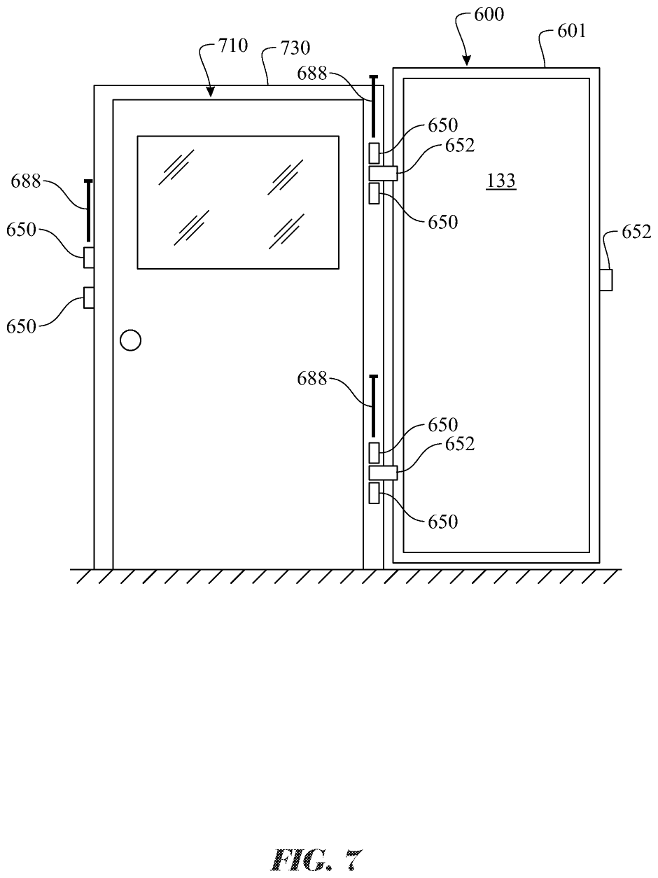

Turning now to FIG. 7, an alternate embodiment is illustrated wherein a white board ballistic panel 600 is constructed in the same manner as ballistic panel 100 in FIG. 1. The ballistic panel 600 has a frame assembly 610 containing the three aforementioned panels, a display board (such as a dry erase white board, magnetic or non-magnetic, blackboard, or bulletin board) visible at a front of the ballistic panel 600, a ballistic panel, and a backing panel which may or may not have a display board surface exposed at the back of the ballistic panel 600. The ballistic panel 600 includes hinge brackets 652 attached to the vertical side of the ballistic panel 600. The door frame includes mounting brackets 650 affixed to the door frame 730 and positioned correspondingly to the hinge brackets on the ballistic panel 600. Pins 688 are inserted in the mounting brackets 650 and hinge brackets 652 to secure the ballistic panel 600 to the door frame 730 in a manner such that the ballistic panel 600 can rotate about one side of the door frame 730.

During regular classes the ballistic panel has the display board surface 133 facing the room for use by a teacher to write upon with generic dry erase markers or to post objects on. In the event of an attack by someone with a firearm, the ballistic panel 600 can be rotated to cover the door 710 with the additional pin 688 engaging the other side of the ballistic panel 600 and thus shield the people within the room from gunfire as well as blocking the doorway from being entered by a shooter.

The above description is considered that of certain embodiments of the present invention only. Modifications of the invention will occur to those skilled in the art and to those who make or use the invention. Such modifications include, but are not limited to, for example, the materials of the invention, its size, and so forth, without limitation. Therefore, it is understood that the embodiments described herein are merely for illustrative purposes only and are not intended to limit the scope of the invention hereof.

I claim:

1. A display board ballistic shield for use in school classrooms to protect students from gunfire, the shield comprising:
a polygonal metal frame constructed of a plurality of lengths of angle elements, the angle legs in one plane forming a frame defining a window area and the angle legs extending at right angles from the plane of the frame defining a polygonal recess;
a display board panel within the polygonal recess, the display board surface accessible through the window;
a ballistic resistant panel within the polygonal recess and abutting the display board;
a backing board within the polygonal recess and abutting the ballistic resistant panel; and
a plurality of gussets affixed at corners of adjoining lengths of angle elements to retains the display board panel, the ballistic resistant panel, and the backing board within the polygonal recess.

2. The display board ballistic shield according to claim 1 wherein the metal frame is constructed of steel angles.

3. The display board ballistic shield according to claim 1 wherein the display board panel is magnetic.

4. The display board ballistic shield according to claim 1 wherein the backing board is configured as a display board panel, the display board surface facing opposite from the window.

5. The display board ballistic shield according to claim 1 wherein the polygonal metal frame includes hinge brackets affixed to a first side of the metal frame for mating with mounting brackets affixed to a door frame.

6. The display board ballistic shield according to claim 5 wherein the polygonal metal frame rotates about the hinge brackets and rotates to cover a door mounted to the door frame.

7. The display board ballistic shield according to claim 1 further including a base frame movably supporting the display board ballistic shield, the base frame including:
two vertical upright posts laterally separated one from the other;
a lateral tube connected to the bottoms of the upright posts, the vertical upright posts and lateral tube defining a vertical plane;
a base leg affixed to the bottom of each vertical upright post and oriented perpendicularly to the vertical plane; and
a caster affixed proximate to the ends of each of the base legs.

8. A display board ballistic shield for use in school classrooms to protect students from gunfire, the shield comprising:
a vertically oriented rectangular frame having two sides, a top, and a bottom, the frame defining a vertical plane, the frame defining a window area therethrough;
a ballistic resistant panel mounted within the frame and coplanar therewith;
a base leg having two ends and affixed to each side of the frame at a bottom thereof, each base leg perpendicularly oriented to the plane defined by the frame; and
a caster affixed proximate to the ends of each of the base legs.

9. The display board ballistic shield according to claim 8 further including at least one handle affixed to the frame.

10. The display board ballistic shield according to claim 8 wherein the rectangular frame defines a central window area and further including a display board panel mounted within the frame in layered fashion with the ballistic resistant panel, the display board panel having a display board surface for erasable marking thereon, the display board surface visible through the window area defined by the frame.

11. The display board ballistic shield according to claim 10 further including a backing panel mounted within the frame in layered fashion with the ballistic resistant panel and on an opposite side of the ballistic resistant panel from the display board panel.

12. The display board ballistic shield according to claim 11 wherein the backing panel is a second display board panel, the display board surface of the second panel oriented facing oppositely from the display board surface of the first display board panel.

13. A display board ballistic shield for use in school classrooms to protect students from gunfire, the shield comprising:
a U-shaped base frame comprising a vertically oriented rectangular frame having two vertical posts, a top, and a bottom, the frame defining a vertical plane and a window area therethrough;
a base leg having two ends and affixed to each side of the frame at a bottom thereof, each base leg perpendicularly oriented to the plane defined by the frame; and
a caster affixed proximate to the ends of each of the base legs
a first ballistic resistant panel having a rectangular metal frame and mounted within a bottom portion of the frame and coplanar therewith; and
a second ballistic resistant panel having a rectangular metal frame and mounted within a top portion of the frame, the second ballistic resistant panel also including a display board abutting in layered fashion the second ballistic resistant panel.

14. The display board ballistic shield according to claim 13 wherein a bottom of the second ballistic resistant panel overlaps the top of the first ballistic resistant panel.

15. The display board ballistic shield according to claim 14 wherein the second ballistic resistant panel rotates about a horizontal axis with respect to the base frame.

16. The display board ballistic shield according to claim 13 wherein the ends of the base legs on one side of the shield define a vertical hole therethrough, the base leg ends being received in a bracket affixed to each side of a doorframe, the brackets defining a vertical hole therethrough such that when the base legs are received in the brackets, a pin can be inserted through the aligned holes to lock the ballistic shield to the doorframe.

17. The display board ballistic shield according to claim 13 wherein a first vertical post includes at least one bracket affixed thereto and a second vertical post includes at least one mating bracket affixed thereto in horizontal alignment with the bracket affixed to the first vertical post such that multiple display board ballistic shields can be affixed one to the other in a daisy-chain manner to create an extended display board ballistic shield wall.

18. The display board ballistic shield according to any of claims 1-17, wherein the display board functions as a dry erase board.

19. The display board ballistic shield according to any of claims 1-17, wherein the display board functions as a blackboard.

20. The display board ballistic shield according to any of claims 1-17, wherein the display board functions as a bulletin board.
